(19) United States
(12) Patent Application Publication
(10) Pub. No.: US 2015/0022635 A1
(43) Pub. Date: Jan. 22, 2015

(54) USING MULTIPLE FLASHES WHEN OBTAINING A BIOMETRIC IMAGE

(71) Applicant: BlackBerry Limited, Waterloo (CA)

(72) Inventor: Peter MANKOWSKI, Waterloo (CA)

(73) Assignee: BlackBerry Limited, Waterloo (CA)

(21) Appl. No.: 13/946,143

(22) Filed: Jul. 19, 2013

(51) Int. Cl. G06K 9/00; H04N 5/235; H04N 13/02

(52) U.S. Cl. CPC G06K 9/00013; H04N 13/0296; H04N 13/0253; H04N 5/2354
USPC 348/46

(57) ABSTRACT

A mobile communication device may have a photography subsystem, multiple light sources on a posterior side and an image signal processor (ISP). The ISP may control the photography subsystem and the timing of the flashing of the multiple light sources to obtain multiple images. From the multiple images, the ISP may construct a three-dimensional biometric.

### FIELD

The present application relates generally to authentication for a computing device and, more specifically, to using multiple flashes when obtaining a biometric image.

### BACKGROUND

As mobile telephones have received increasing amounts of computing power in successive generations, the mobile telephones have been termed “smart phones.” Along with increasing amounts of computing power, such smart phones have seen increases in storage capacity, processor speed and networking speed. Consequently, smart phones have been seen to have increased utility. Beyond telephone functions, smart phones may now send and receive digital messages, be they formatted to use e-mail standards, Short Messaging Service (SMS) standards, Instant Messaging standards and proprietary messaging systems. Smart phones may also store, read, edit and create documents, spreadsheets and presentations. Accordingly, there have been increasing demands for smart phones with enhanced authentication functions.

### BRIEF DESCRIPTION OF THE DRAWINGS

Reference will now be made, by way of example, to the accompanying drawings which show example implementations; and in which:

FIG. 1 illustrates an anterior side of a mobile communication device;

FIG. 2 illustrates an example arrangement of internal components of the mobile communication device of FIG. 1;

FIG. 3 illustrates a posterior side of the mobile communication device of FIG. 1;

FIG. 4 schematically illustrates the mobile communication device of FIG. 1 resting on a surface; and

FIG. 5 illustrates example steps in a method of obtaining three-dimensional biometric image.

### DETAILED DESCRIPTION

A mobile communication device may have a photography subsystem, multiple light sources on a posterior side and an image signal processor (ISP). The ISP may control the photography subsystem and the timing of the flashing of the multiple light sources to obtain multiple images. From the multiple images, the ISP may construct a three-dimensional biometric.

According to an aspect of the present disclosure, there is provided a method of obtaining a three-dimensional biometric image. The method includes sending an instruction to a first light source to flash, sending an instruction to a photography subsystem to obtain a first image corresponding to the flash from the first light source, receiving, from the photography subsystem, the first image, sending an instruction to a second light source to flash, sending an instruction to the photography subsystem to obtain a second image corresponding to the flash from the second light source, receiving, from the photography subsystem, the second image and constructing a three-dimensional image from the first image and the second image. In other aspects of the present application, an image signal processor is provided for carrying out this method and a computer readable medium is provided for adapting an image signal processor to carry out this method.

According to an aspect of the present disclosure, there is provided a mobile communication device. The mobile communication device includes a photography subsystem, a first light source on a posterior side of the mobile communication device, a second light source on an anterior side of the mobile communication device and an image signal processor. The image signal processor is adapted to send an instruction to the first light source to flash, send an instruction to the second light source to flash, send an instruction to the photography subsystem to obtain an image, receive, from the photography subsystem, the image.

Other aspects and features of the present disclosure will become apparent to those of ordinary skill in the art upon review of the following description of specific implementations of the disclosure in conjunction with the accompanying figures.

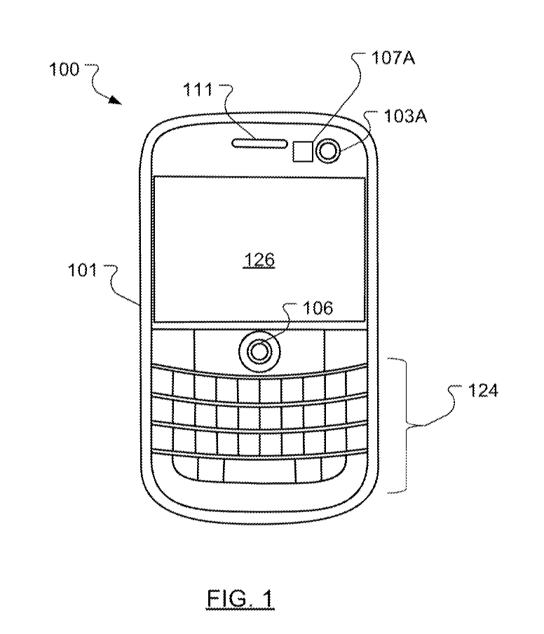

FIG. 1 illustrates an anterior side of a mobile communication device 100. Many features of the anterior side of the mobile communication device 100 are mounted within a housing 101 and include a display 126 a keyboard 124 having a plurality of keys, a speaker 111, a navigation device 106 (e.g., a touchpad, a trackball, a touchscreen, an optical navigation module) and an anterior (user-facing) lens 103A.

The anterior side of the mobile communication device 100 includes an anterior Light Emitting Diode (LED) 107A for use as a flash when using the mobile communication device 100 to capture, through the anterior lens 103A, a still photograph.

The mobile communication device 100 includes an input device (e.g., the keyboard 124) and an output device (e.g., the display 126), which may comprise a full graphic, or full color, Liquid Crystal Display (LCD). In some implementations, the display 126 may comprise a touchscreen display. In such touchscreen implementations, the keyboard 124 may comprise a virtual keyboard provided on the display 126. That is, the display 126 encompasses essentially the entirety of the anterior side of the device 100. Other types of output devices may alternatively be utilized.

The housing 101 may be elongated vertically, or may take on other sizes and shapes (including clamshell housing structures). In the case in which the keyboard 124 includes keys that are associated with at least one alphabetic character and at least one numeric character, the keyboard 124 may include a mode selection key, or other hardware or software, for switching between alphabetic entry and numeric entry.

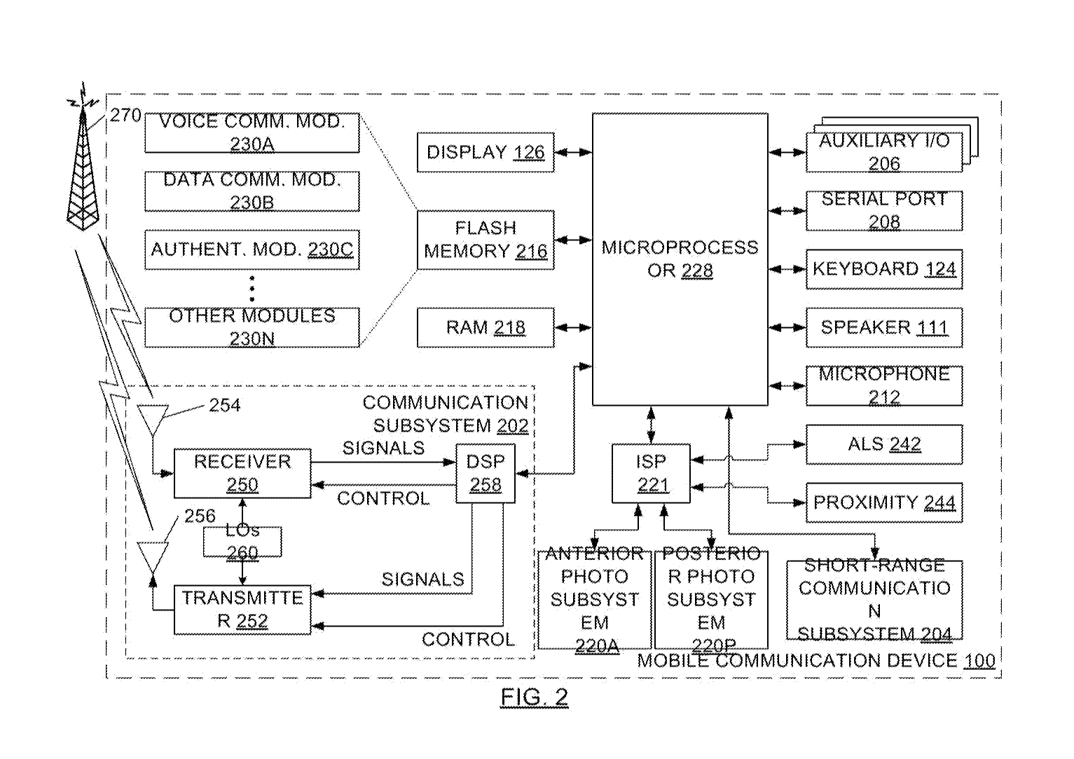

FIG. 2 illustrates an example arrangement of internal components of the mobile communication device 100. A processing device (a microprocessor 228) is shown schematically in FIG. 2 as coupled between the keyboard 124 and the display 126. The microprocessor 228 controls the operation of the display 126, as well as the overall operation of the mobile communication device 100, in part, responsive to actuation of the keys on the keyboard 124 by a user.

In addition to the microprocessor 228, other parts of the mobile communication device 100 are shown schematically in FIG. 2. These may include a communications subsystem 202, a short-range communications subsystem 204, the keyboard 124 and the display 126. The mobile communication device 100 may further include other input/output devices, such as a set of auxiliary I/O devices 206, a serial port 208, the speaker 111 and a microphone 212. The mobile communication device 100 may further include memory devices including a flash memory 216 and a Random Access Memory (RAM) 218 as well as various other device subsystems. The mobile communication device 100 may comprise a two-way, radio frequency (RF) communication device having voice and data communication capabilities. In addition, the mobile communication device 100 may have the capability to communicate with other computer systems via the Internet.

Operating system software executed by the microprocessor 228 may be stored in a computer readable medium, such as the flash memory 216, but may be stored in other types of memory devices, such as a read only memory (ROM) or similar storage element. In addition, system software, specific device applications, or parts thereof, may be temporarily loaded into a volatile store, such as the RAM 218. Communication signals received by the mobile device may also be stored to the RAM 218.

The microprocessor 228, in addition to its operating system functions, enables execution of modules on the mobile communication device 100. A predetermined set of software applications that control basic device operations, such as a voice communications module 230A and a data communications module 230B, may be installed on the mobile communication device 100 during manufacture. An authentication module 230C may also be installed on the mobile communication device 100 during manufacture, to implement aspects of the present disclosure. As well, additional software modules, illustrated as an other software module 230N, which may be, for instance, a PIM application, may be installed during manufacture. The PIM application may be capable of organizing and managing data items, such as e-mail messages, calendar events, voice mail messages, appointments and task items. The PIM application may also be capable of sending and receiving data item via a wireless carrier network 270 represented by a radio tower. The data items managed by the PIM application may be seamlessly integrated, synchronized and updated via the wireless carrier network 270 with the device user's corresponding data items stored or associated with a host computer system.

These modules 230A, 230B, 230C, 230N may, for one example, comprise a combination of hardware (say, a dedicated processor, not shown) and software (say, a software application arranged for execution by the dedicated processor) or may, for another example, comprise a software application arranged for execution by the microprocessor 228.

Communication functions, including data and voice communications, are performed through the communication subsystem 202 and, possibly, through the short-range communications subsystem 204. The communication subsystem 202 includes a receiver 250, a transmitter 252 and one or more antennas, illustrated as a receive antenna 254 and a transmit antenna 256. In addition, the communication subsystem 202 also includes a processing module, such as a digital signal processor (DSP) 258, and local oscillators (LOs) 260. The specific design and implementation of the communication subsystem 202 is dependent upon the communication network in which the mobile communication device 100 is intended to operate. For example, the communication subsystem 202 of the mobile communication device 100 may be designed to operate with the Mobitex™, DataTAC™ or General Packet Radio Service (GPRS) mobile data communication networks and also designed to operate with any of a variety of voice communication networks, such as Advanced Mobile Phone Service (AMPS), Time Division Multiple Access (TDMA), Code Division Multiple Access (CDMA), Personal Communications Service (PCS), Global System for Mobile Communications (GSM), Enhanced Data rates for GSM Evolution (EDGE), Universal Mobile Telecommunications System (UMTS), Wideband Code Division Multiple Access (W-CDMA), High Speed Packet Access (HSPA), etc. Other types of data and voice networks, both separate and integrated, may also be utilized with the mobile communication device 100.

Network access requirements vary depending upon the type of communication system. Typically, an identifier is associated with each mobile device that uniquely identifies the mobile device or subscriber to which the mobile device has been assigned. The identifier is unique within a specific network or network technology. For example, in Mobitex™ networks, mobile devices are registered on the network using a Mobitex Access Number (MAN) associated with each device and in DataTAC™ networks, mobile devices are registered on the network using a Logical Link Identifier (LLI) associated with each device. In GPRS networks, however, network access is associated with a subscriber or user of a device. A GPRS device therefore uses a subscriber identity module, commonly referred to as a Subscriber Identity Module (SIM) card, in order to operate on a GPRS network. Despite identifying a subscriber by SIM, mobile devices within GSM/GPRS networks are uniquely identified using an International Mobile Equipment Identity (IMEI) number.

When required network registration or activation procedures have been completed, the mobile communication device 100 may send and receive communication signals over the wireless carrier network 270. Signals received from the wireless carrier network 270 by the receive antenna 254 are routed to the receiver 250, which provides for signal amplification, frequency down conversion, filtering, channel selection, etc., and may also provide analog to digital conversion. Analog-to-digital conversion of the received signal allows the DSP 258 to perform more complex communication functions, such as demodulation and decoding. In a similar manner, signals to be transmitted to the wireless carrier network 270 are processed (e.g., modulated and encoded) by the DSP 258 and are then provided to the transmitter 252 for digital to analog conversion, frequency up conversion, filtering, amplification and transmission to the wireless carrier network 270 (or networks) via the transmit antenna 256.

In addition to processing communication signals, the DSP 258 provides for control of the receiver 250 and the transmitter 252. For example, gains applied to communication signals in the receiver 250 and the transmitter 252 may be adaptively controlled through automatic gain control algorithms implemented in the DSP 258.

In a data communication mode, a received signal, such as a text message or web page download, is processed by the communication subsystem 202 and is input to the microprocessor 228. The received signal is then further processed by the microprocessor 228 for output to the display 126, or alternatively to some auxiliary I/O devices 206. A device user may also compose data items, such as e-mail messages, using the keyboard 124 and/or some other auxiliary I/O device 206, such as the navigation device 106, a touchpad, a rocker switch, a thumb-wheel, a trackball, a touchscreen, or some other type of input device. The composed data items may then be transmitted over the wireless carrier network 270 via the communication subsystem 202.

In a voice communication mode, overall operation of the device is substantially similar to the data communication mode, except that received signals are output to the speaker 111, and signals for transmission are generated by a microphone 212. Alternative voice or, audio I/O subsystems, such as a voice message recording subsystem, may also be implemented on the mobile communication device 100. In addition, the display 126 may also be utilized in voice communication mode, for example, to display the identity of a calling party, the duration of a voice call, or other voice call related information.

The short-range communications subsystem 204 enables communication between the mobile communication device 100 and other proximate systems or devices, which need not necessarily be similar devices. For example, the short-range communications subsystem may include an infrared device and associated circuits and components, or a Bluetooth™ communication module to provide for communication with similarly-enabled systems and devices.

An anterior photography subsystem 220A and a posterior photography subsystem 220P connect to the microprocessor 228 via an Image Signal Processor (ISP) 221. Indeed, the anterior photography subsystem 220A and the posterior photography subsystem 220P each include a communication interface (not shown) for managing communication with the ISP 221.

The mobile communication device 100 further includes an ambient light sensor (ALS) 242 and a proximity detector 244, each in communication with the ISP 221. The ALS may be, for example, Light-to-Digital Converter TSL2572 from Texas Advanced Optoelectronic Solutions of Plano, Tex. Ambient light sensor systems are described in U.S. Patent Application recently filed for the present applicant.

The following disclosures are incorporated by reference herein in their entirety: (1) Performance Control of Ambient Light Sensors, U.S. patent application Ser. No. 13/932,235: (2) Password by Touch-less Gesture, U.S. patent application Ser. No. 13/932,243: (3) Touch-less User Interface Using Ambient Light Sensors, U.S. patent application Ser. No. 13/932,250; (4) Camera Control Using Ambient Light Sensors U.S. patent application Ser. No. 13/932,260: (5) Display Navigation Using Touch-less Gestures, U.S. patent application Ser. No. 13/932,271; (6) Alarm Operation by Touch-less Gesture, U.S. patent application Ser. No. 13/932,280; and (7) Gesture Detection Using Ambient Light Sensors, U.S. patent application Ser. No. 13/932,470.

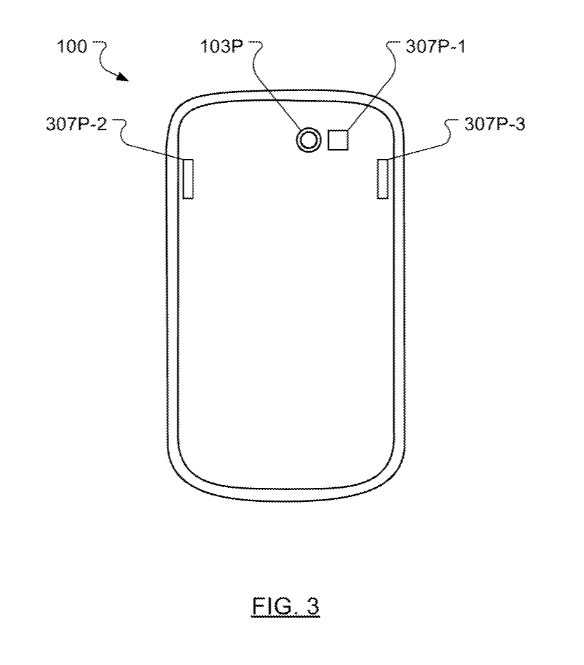

FIG. 3 illustrates a posterior side of the mobile communication device 100. Included on the posterior side are a posterior lens 103P and a primary posterior LED 307P-1 for use as a flash when using the mobile communication device 100 to capture, through the posterior lens 103P, a still photograph. The primary posterior LED 307P-1 may also be used as a torch to provide light when the mobile communication device 100 is used to capture, through the posterior lens 103P, video in low ambient light. Also included on the posterior side are a secondary posterior LED 307P-2 and a tertiary posterior LED 307P-3. The use of the secondary posterior LED 307P-2 and the tertiary posterior LED 307P-3 will be described in the following.

Fingerprints are typically obtained, when using electronics, by way of a Complementary Metal Oxide Semiconductor (CMOS) based sensor. In use, a user is required to touch the CMOS-based sensor by resting a finger on the sensor.

The requirement to touch the sensor may be seen as limiting the use of fingerprint-based biometric authentication. For example, fingerprint-based biometric authentication may be avoided in medical applications, since frequent sterilization may damage the CMOS-based sensor and reduce the sensitivity of the CMOS-based sensor.

In overview, it is proposed herein to employ multiple light sources when obtaining multiple images of a biometric (e.g., a fingerprint). With appropriate Digital Signal Processing, three dimensional biometric information may be used for authentication. Conveniently, the approach described herein does not require the user to touch a sensor.

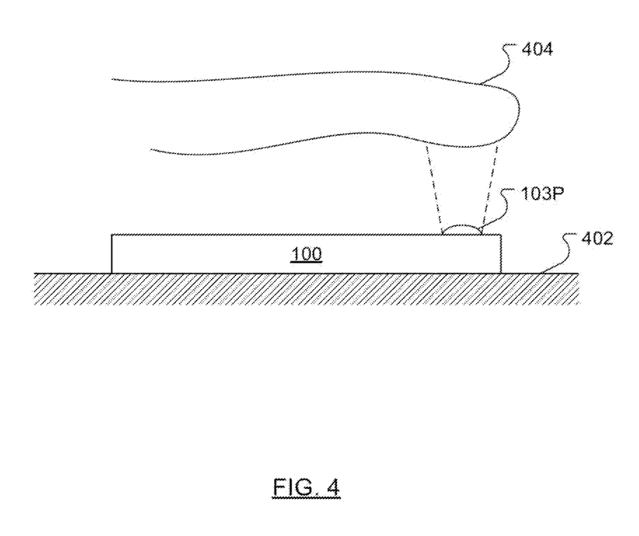

FIG. 4 schematically illustrates the mobile communication device 100 resting on a surface 402. A finger 404 is illustrated in a position wherein the posterior photography subsystem 220P may receive input via the posterior lens 103P. The posterior photography subsystem 220P may generate, based on the input, an image of a fingerprint on the finger 404 being presented to the posterior lens 103P. The image is known to be “flat.” That is, the image obtained by the photography subsystem 220 typically does not include depth information.

A real fingerprint has ridges and valleys. Accordingly, strides have been made and are being made in the area of performing authentication using three dimensional fingerprints. However, there is, as yet, no standard for an effective method of measuring fingerprint coordinates in three (x, y and z) dimensions using the high resolution camera systems that have recently been included in mobile communication devices.

In operation, the ISP 221 controls timing, interrupts and luminescent intensity for selected ones of the anterior LED 107A, the primary posterior LED 307P-1, the secondary posterior LED 307P-2 and the tertiary posterior LED 307P-3.

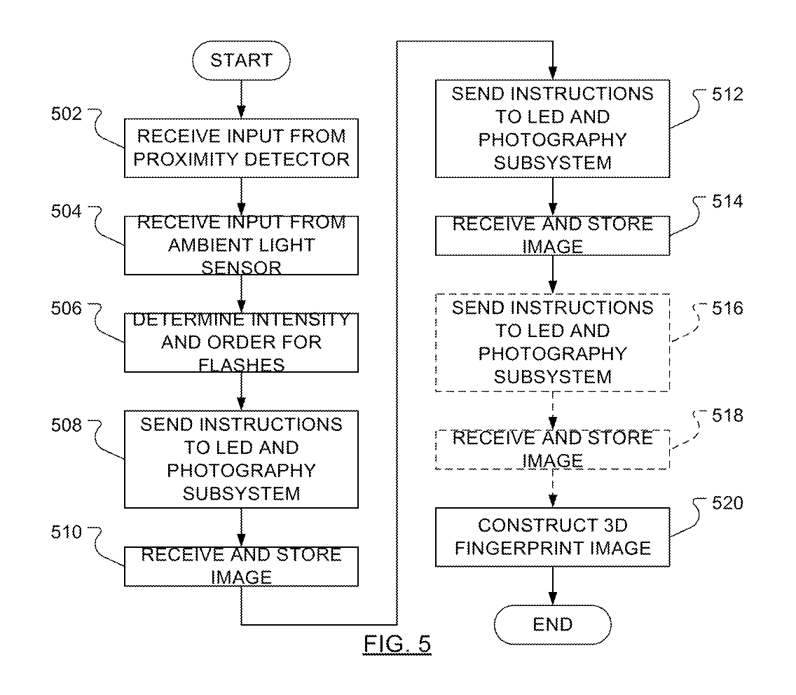

FIG. 5 illustrates example steps in a method of obtaining a three-dimensional biometric image. A user of the mobile communication device 100 may be instructed, for example, by instructions provided on the display 126, to provide a finger to the posterior lens 103P for authentication.

Responsively, the user may provide the finger 404 to the posterior lens 103P, as illustrated in FIG. 4. The ISP 221 may receive (step 502) input from the proximity detector 244, the input from the proximity detector 244 indicating a distance between the posterior lens 103P and the finger 404. The ISP 221 may then receive (step 504) input from the ALS 242, the input from the ALS 242 indicating a measure of the ambient light of the instant environment of the mobile communication device 100.

Based upon, perhaps, such factors as the distance between the posterior lens 103P and the finger 404 and the measure of the ambient light, the ISP 221 may determine (step 506) an order of activation for the secondary posterior LED 307P-2 and the tertiary posterior LED 307P-3 and, if desired, the primary posterior LED 307P-1. Optionally, based upon many of the same factors, the ISP 221 may determine (step 506) a luminescent intensity for the secondary posterior LED 307P-2 and the tertiary posterior LED 307P-3 and, if desired, the primary posterior LED 307R-1.

Consider, for example, that the ISP 221 determines (step 506) the order of activation to be the secondary posterior LED 307P-2 followed by the tertiary posterior LED 307P-3 followed by the primary posterior LED 307P-1.

The ISP 221 then sends (step 508) a flash instruction to the secondary posterior LED 307P-2 and an obtain image instruction to the posterior photographic subsystem 220P. The flash instruction may include such information as when to flash, a duration for the flash and a luminescent intensity for the flash. Upon obtaining a first image, the posterior photographic subsystem 220P transmits the first image to the ISP 221. The ISP 221 receives and stores (step 510) the first image.

The ISP 221 then sends (step 512) a flash instruction to the tertiary posterior LED 307P-3 and an obtain image instruction to the posterior photographic subsystem 220P. Upon obtaining a second image, the posterior photographic subsystem 220P transmits the second image to the ISP 221. The ISP 221 receives and stores (step 514) the second image.

Optionally, the ISP 221 then sends (step 516) a flash instruction to the primary posterior LED 307P-1 and an obtain image instruction to the posterior photographic subsystem 220P. Upon obtaining a third image, the posterior photographic subsystem 220P transmits the third image to the ISP 221. The ISP 221 receives and stores (step 518) the third image.

It is expected that the flash from the secondary posterior LED 307P-2 will illuminate areas of the finger 404 while causing shadows to fall across other areas of the finger 404. Similarly, it is expected that the flash from the tertiary posterior LED 307P-3 will illuminate areas of the finger 404 while causing shadows to fall across other areas of the finger 404. These shadows may be considered to expose a limited degree of depth in the fingerprint of the finger 404. Accordingly, the ISP 221 may base a decision regarding whether a flash from the primary posterior LED 307P-1 is desired upon, perhaps, such factors as the distance between the posterior lens 103P and the finger 404 and the measure of the ambient light.

It is also contemplated that more than three LEDs may be installed on the posterior side of the mobile communication device 100.

Upon receiving and storing the two or three (or more) obtained images, the ISP 221 processes (step 520) the, images to construct a three-dimensional fingerprint image. It should be clear to a person of ordinary skill in the art that biometrics other than fingerprints may be constructed in a similar manner.

The three-dimensional fingerprint image may be constructed in a raw image format with three-dimensional information. Before outputting the three-dimensional fingerprint image to the microprocessor 228, the ISP 221 may subject the three-dimensional fingerprint image to, a rebalancing and smoothing algorithm.

For authentication, consider that a template three-dimensional fingerprint image has been generated and stored at a time of registration with a fingerprint authentication system. In a future authentication attempt, a user presents a finger to the mobile communication device 100 in the manner described hereinbefore. A processor, perhaps the microprocessor 228 or perhaps, a dedicated processor as part of the fingerprint authentication system, obtains a candidate three-dimensional fingerprint image from the ISP 221. The processor analyzes a correspondence between the candidate three-dimensional fingerprint image and the stored template three-dimensional fingerprint image. Responsive to determining a degree of correspondence surpassing a threshold, the processor may grant the user access to that which is protected by the fingerprint authentication system. Responsive to determining a degree of correspondence that fails to surpass the threshold, the processor may deny the user access to that which is protected by the fingerprint authentication system.

Beyond the application to three-dimensional fingerprint capture, the provision of multiple LEDs on the posterior side of the mobile communication device 100 is contemplated to improve photography in general, as captured by the mobile communication device 100. Typically. mobile communication devices of the current era include a single flash LED on the device's posterior side. The multiple posterior LEDs (307-P1, 307-P2, 307P3) of the mobile communication device 100 may be shown to enhance photographs captured by reducing shadows or controlling where such shadows fall on the subject of a given photograph.

It is known, particularly in portrait photography, to use an indirect flash instead of, or along with, a direct flash. That is, professional photographers will sometimes achieve improvements in photographing a particular subject by having one or more flashes aimed at the subject directly and one or more flashes directed away from the subject. The one or more flashes directed away from the subject light the subject based on reflections from purpose-built reflectors and/or reflections from walls and objects in a room where the photograph is being taken.

When a given photograph is to be obtained by the mobile communication device 100, the ISP 221 may control timing, interrupts and luminescent intensity for selected ones of the anterior LED 107A, the primary posterior LED 307P-1, the secondary posterior LED 307P-2 and the tertiary posterior LED 307P-3. The ISP 221 may, in addition, control timing and exposure for capture of the image by the posterior photographic subsystem 220P.

Though not illustrated in FIG. 1, it is further contemplated that multiple LEDs may also be present on the anterior side of the mobile communication device 100. Such placement of LEDs may allow for three dimensional self portraits and further photographic effects, many of which have been discussed in relation to the multiple LEDs on the posterior side.

It is contemplated that situations in which the mobile communication device 100 with the combination of the primary posterior LED 307P-1, the secondary posterior LED 307P-2 and the tertiary posterior LED 307P-3 may be employed include: for fingerprint 3D modeling and detection; as a tool for visually impaired users of the mobile communication device 100 helping to alerting the user of environment ahead and around; using, a single built-in camera to achieve partial “3D-like effect” by closely controlling a sequence of enabling three flash LEDs; and enhancements to 3D shape recognition. More particularly, the enhancements to 3D shape recognition may include uses in construction, for instance, determining whether a particular piece of lumber is 2×4 or 4×6. Furthermore, the enhancements to 3D shape recognition may include uses in security; for instance, in a face recognition application, having three flash LEDs allows the mobile communication device 100 to determine whether the posterior lens 103P is turned toward a portrait (say, a photograph or a painting) or an actual human face with inherent three dimensions.

It is further contemplated that some of the light sources, LEDs 107A, 307P-1, 307P-2 and 307P-3 may be adapted to provide structured light to assist in the 3D determination. Examples of structured light are described in U.S. patent application Ser. No. 13/936,017, filed Jul. 5, 2013 (associated with attorney docket 42783-3755), which is incorporated herein for any purpose,

The above-described implementations of the present application are intended to be examples only. Alterations, modifications and variations may be effected to the particular implementations by those skilled in the art without departing from the scope of the application, which is defined by the claims appended hereto.

What is claimed is:

1. A method of obtaining a three-dimensional biometric image, the method comprising:
sending an instruction to a first light source to flash;
sending an instruction to a photography subsystem to obtain first image corresponding to the flash from the first light source;
receiving, from a the photography subsystem, the first image;
sending an instruction to a second light source to flash;
sending an instruction to the photography subsystem to obtain second image corresponding to the flash from the second light source;
receiving, from the photography subsystem, the second image; and
constructing a three-dimensional image from the first image and the second image.

2. The method of claim 1 wherein the first light source comprises a light emitting diode.

3. The method of claim 1 further comprising:
sending an instruction to a third light source to flash; and
sending an instruction to the photography subsystem to obtain a third image corresponding to the flash from the third light source.

4. The method of claim 1 further comprising determining a temporal order for the flash from the first light source and the flash from the second light source.

5. The method of claim 4 wherein the instruction to the first light source comprises an indication of timing for the flash.

6. The method of claim 4 wherein the instruction to the first light source comprises an indication of duration for the flash.

7. The method of claim 4 wherein the instruction to the first light source comprises an indication of luminescent intensity for the flash.

8. The method of claim 4 further comprising:
receiving input from a proximity sensor;
wherein the determining is based, at least in part, on the input.

9. The method of claim 4 further comprising:
receiving input from an ambient light sensor;
wherein the determining is based, at least in part, on the input.

10. A mobile communication device comprising:
a photography subsystem;
a first light source on a posterior side of the mobile communication device;
a second light source on the posterior side of the mobile communication device:
an image signal processor adapted to:
send an instruction to the first light source to flash;
send an instruction to the photography subsystem to obtain a first image corresponding to the flash from the first light source;
receive, from the photography subsystem, the first image;
send an instruction to the second light source to flash;
send an instruction to the photography subsystem to obtain a second image corresponding to the flash from the second light source;
receive, from the photography subsystem the second image; and
construct a three-dimensional image from the first image and the second image.

11. The device of claim 10 wherein the first light source comprises a light emitting diode.

12. The device of claim 10 further comprising:
a third light source;
wherein the image signal processor is further adapted to:
send an instruction to the third light source to flash; and
send an instruction to the photography subsystem to obtain a third image corresponding to the flash from the third light source.

13. The device of claim 10 wherein the image signal processor is further adapted to determine a temporal order for the flash from the first light source and the flash from the second light source.

14. The device of claim 13 wherein the instruction to the first light source comprises an indication of timing for the flash.

15. The device of claim 13 wherein the instruction to the first light source comprises an indication of duration for the flash.

16. The device of claim 13 wherein the instruction to the first light source comprises an indication of luminescent intensity for the flash.

17. The device of claim 13 further comprising a proximity sensor, wherein the image signal processor is further adapted to receive input from the proximity sensor and wherein the determining is based, at least in part, on the input.

18. The device of claim 13 further comprising an ambient light sensor, wherein the image signal processor is further adapted to receive input from the ambient light sensor and wherein the determining is based, at least in part, on the input.

19. A computer readable medium containing computer-executable instructions that, when performed by an image signal processor in a mobile communication device having a photography subsystem, a first light source and a second light source, cause the image signal processor to:
send an instruction to the first light source to flash;
send an instruction to the photography subsystem to obtain a first image corresponding to the flash from the first light source;
receive the first image;
send an instruction to the second light source to flash;
send an instruction to the photography subsystem to obtain a second image corresponding to the flash from the second light source;
receive, from the photography subsystem, the second image; and
construct a three-dimensional image from the first image and the second image.

20. A mobile communication device comprising:
a photography subsystem;
a first light source on a posterior side of the mobile communication device;
a second light source on an anterior side of the mobile communication device;
an image signal processor adapted to:
send an instruction to the first light source to flash;
send an instruction to the second light source to flash;
send an instruction to the photography subsystem to obtain an image;
receive, from the photography subsystem, the image.
